(19) United States
(12) Patent Application Publication
(10) Pub. No.: US 2024/0253648 A1
(43) Pub. Date: Aug. 1, 2024

(54) Method and Device for Autonomous Movement of a Vehicle in a Variably Optimized Dynamic Driving State

(71) Applicant: Volkswagen Aktiengesellschaft, Wolfsburg (DE)

(72) Inventors: Amira El Amouri, Wolfsburg (DE); Samuel Schacher, Berlin (DE); Björn Mennenga, Braunschweig (DE); Sevsel Gamze Kabil, Braunschweig (DE)

(73) Assignee: Volkswagen Aktiengesellschaft, Wolfsburg (DE)

(21) Appl. No.: 18/424,270

(22) Filed: Jan. 26, 2024

(30) Foreign Application Priority Data
Jan. 27, 2023 (DE) 10 2023 200 693.6

(51) Int. Cl. B60W 50/08; B60W 50/10; B60W 60/00

(52) U.S. Cl. CPC B60W 50/082; B60W 50/10; B60W 60/001; B60W 60/0013

(57) ABSTRACT

Disclosed are methods and devices for autonomous movement of a vehicle in optimized dynamic driving state. A method comprises: detecting environmental data of a vehicle; calculations of a first travel path of the vehicle to a destination, and calculations of a vehicle state at at least one point of this travel path; detecting a driving instruction of a driver; determining a correlation value based on the driving instruction and the precalculated travel path and/or the precalculated vehicle state; checking whether the correlation value falls below a critical limit value; and if the correlation value falls below a critical limit value, converting a data point detected that is characteristic of the state and/or the driving instruction of the driver into a control signal. The control signal then may energize the vehicle on a second travel path leading to the same destination, wherein the vehicle adopts a stable vehicle state.

### CROSS-REFERENCE TO RELATED APPLICATIONS

This application claims priority to German Patent Application No. DE 10 2023 200 693.6, filed on Jan. 27, 2023 with the German Patent and Trademark Office. The contents of the aforesaid Patent Application are incorporated herein for all purposes.

### BACKGROUND

The teachings herein relate to a method for controlling a vehicle by an assistance system, and in particular for autonomous movement of a vehicle in a (variably) optimized dynamic driving state, and a vehicle equipped with a system for controlling a vehicle by an assistance system, and in particular for autonomous movement of a vehicle in a (variably) optimized dynamic driving state.

Vehicles with autonomous driving function in general are known. In some designs, a control apparatus can assume both longitudinal guidance, i.e., the acceleration and braking of the vehicle, as well as transverse guidance, i.e., the steering of the vehicle. Vehicles with such an autonomous driving function can be designed as partially autonomous or fully autonomous. In vehicles driving partially autonomously, control of the vehicle is assumed by the control apparatus only temporarily during certain driving situations. In vehicles driving fully autonomously, the intervention of a human is no longer necessary. The autonomy degree of a vehicle is divided into various levels, wherein vehicles with a higher degree of autonomy are classified in a higher level.

In the future, an increase is expected in vehicles traveling with fully autonomous control. For vehicles classified at an autonomy level 4 or higher, the driving ability of a person located in the vehicle is not a relevant factor for controlling the vehicle or reliably reaching a driving destination.

Even today, level 2+ vehicles are capable of evaluating the situations and driving process and guiding the vehicle, assisting the driving person and/or notifying the driving person of hazards. Modern systems can often assess the driving situation better than human drivers. This is possible in particular due to the huge computing power of the hardware installed in the vehicle and the plurality of sensors available for detecting the traffic situation. These sensors can often detect or identify signals that are not perceptible by a human. Examples of such signals are IR, sonar, radar, lidar and others. Vehicles classified at least at autonomy level 3 can assume control of the vehicle and its driving, at least by segments.

The autonomy of the vehicle offers new possibilities for designing interfaces for communication between human and vehicle. Operating interfaces are expected to adopt new designs in the future. Joysticks, touchpads or, farther in the future, brain-computer interfaces, can take the place of, or respectively, replace conventional control devices, such as steering and pedals. The entire interior of the vehicle can also be redesigned accordingly. With such vehicles, it will no longer be necessary in the future for a vehicle driver to look in the travel direction to be able to observe the traffic situation.

One consequence of this increasing autonomy of the vehicle is that interaction with the driver should be reconceptualized. It is expected that as vehicle autonomy increases, the driving experience of the occupants will decrease. A changed operating interface can possibly result in not all inputs of a driver being transmitted to the vehicle, as previously. For example, direct transmission of the driver input to the vehicle is no longer possible with steering by joystick, since the input signals have to be translated into signals for controlling the vehicle, for example its steering. Such changed input devices can possibly also result in reduced accuracy of the input signal. For example, when using a touchpad to input a driving signal, it could be expected that accuracy decreases compared to a steering wheel. This can result in worsened driving patterns and diminish the driving experience.

Even with vehicles of autonomy level 2+, the vehicle can possess more knowledge and/or skills compared to a human. The more accurate awareness of the driving function, driving situation, the vehicle and its abilities in different driving situations allows such a vehicle to control the vehicle as well as possible. Particularly in combination with by-wire energizing of the actuators, it is possible to combine or consolidate the driving function calculated by the vehicle with an input of an occupant, for example of the driver, and thus to adjust the driving style in deviation from the calculated driving style on request by the driver.

Similarly, some users desire to drive even vehicles of autonomy level 3, 4 or 5 by themselves.

### SUMMARY

A need exists to provide a system for controlling a vehicle that interacts with the driver as desired and adjusts the vehicle control to the desires and/or ability of the driver. Furthermore, a method for controlling a vehicle by an assistance system that adjusts the vehicle control to the desires and/or ability of the driver is needed. The need is addressed by the subject matter of the independent claim(s). Embodiments of the invention are described in the dependent claims, the following description, and the drawings.

### BRIEF DESCRIPTION OF THE DRAWINGS

FIG. 1 shows a schematic representation of a part of the proposed method according to an embodiment;

FIG. 2 shows a schematic representation of a part of the proposed method according to an embodiment;

FIG. 3 shows an exemplary representation for decoupling between human-machine interface and actuator;

FIG. 4 shows an exemplary representation for decoupling between human-machine interface and actuator;

FIG. 5 shows an example representation of a virtual space that is set up by the possible degrees of freedom of the decoupling between the human-machine interface and actuator as well as the feedback;

FIG. 6 shows an example arrangement of a recoupling profile in the virtual space;

FIG. 7 shows an example schematic representation of the working of the assistance system;

FIG. 8 shows an example schematic representation of selected driving modes;

FIG. 9 shows a further schematic representation of a part of the proposed method according to an embodiment;

FIG. 10 shows an example schematic representation of a trip of a vehicle using a method variant;

FIG. 11 shows a further example schematic representation of a trip of a vehicle using a method variant; and

FIG. 12 shows a further example schematic representation of a trip of a vehicle using a method variant.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, a method of controlling a vehicle by an assistance system comprises:
a) detecting environmental data of a vehicle by a sensor (also referred to herein as ‘sensor apparatus’);
b) calculating a first travel path of the vehicle to a destination, and calculating a vehicle state at at least one point of this travel path, based on the environmental data, by means of a first processing circuit (also referred to herein as ‘first computer apparatus’);
c) detecting a driving instruction of a driver by at least one human-machine interface;
d) determining optionally a correlation value based on
the driving instruction and
the precalculated travel path of the vehicle and/or the precalculated vehicle state;
e) checking optionally whether the correlation value falls below a critical correlation limit value by a second processing circuit (also referred to herein as ‘second computer apparatus’), and if the correlation value falls below the critical correlation limit value
f) converting a data point detected by the human-machine interface that is characteristic of the state and/or the driving instruction of the driver into a control signal, which energizes the vehicle or a vehicle component on a second travel path leading to the same destination, wherein the vehicle adopts a stable vehicle state at every point of this second travel path.

By this method, it is possible for the driver to intervene in the vehicle control and can thus fulfill his desire to control the vehicle. Furthermore, it is possible for the driver himself to influence the driving style of the vehicle within a certain scope. At the same time, the vehicle itself prevents the vehicle from ending up in an uncontrollable or critical state due to a driving instruction of the driver. Rather, even with intervention of the driver, the vehicle always remains on a travel path leading to the preset driving destination and in a stable vehicle state at every point of this travel path.

In this context and in some embodiments, it is not necessary for the driver to independently control all functions to guide the vehicle on the travel path to the destination of the vehicle. Thus it is conceivable, for example, that the driver merely steers and the (positive or negative) acceleration of the vehicle is effected by the assistance system. It is also conceivable that the driver presets (manually or semi-automatically) switching states of a gear to operate the engine of the vehicle in, for example, an especially high-revving speed range that is perceived as sporty, or another speed range that is especially energy-saving. For example, the driver can thus select which vehicle component(s) he wants to control independently and which control(s) should be effected by the assistance system. For example, the vehicle components not assumed by the driver are controlled by the assistance system, wherein for example, this control is adapted to the vehicle control commands of the driver.

In some embodiments, at least one of the steps a) to f), for example multiple of the steps a) to f), or multiple of the steps b), d) e) and f), in particular for example all of the steps b), d) e) and f) are carried out computer-assisted, for example as computer-implemented method steps.

Following on the term ADAS (Advanced Driver Assistance System), an assistance system that enables a vehicle control as described above can be referred to as an Advanced Driving Enhancement System (ADES) since it not only makes it possible to assist the driver, but rather even to improve or enhance the driving experience.

For example, such a method makes it possible for the driver to directly exert influence on the driving style of the vehicle through his control commands. In this context, the driver may have the feeling that he himself is carrying out the control of the vehicle or at least that of the vehicle components he has selected for self-control, and only the other vehicle components are adapted to his inputs by the assistance system. The driver's driving experience can be adapted to his preferences thereby. For example, the assistance system adapts the control of remaining components not controlled by the driver to the driving style that is derived from the control signals of the driver. Thus depending on the desires of the driver and/or occupants, the driving can be structured more comfortably, efficiently and/or more sporty. This may for example occur without disruptive effect on the control feeling as perceived by the driver.

For example, the second travel path is calculated taking into account data regarding a driving mode and/or a driving characteristic of a driver, multiple drivers and/or a driver group. These can be derived from a direct control command of the driver. However, it is conceivable and for example possible that prior control commands are also relied on, for example prior control commands during the present trip. For example, control commands of the driver are therefore stored in a database. This database can comprise entries about the present trip, but also about various trips. For example, the database entries are associated with certain drivers or vehicle occupants. Thereby it is possible, for example, after recognition by the assistance system of a driver who is currently driving, to load a dataset appropriate for this driver (and, if applicable, additional vehicle occupants) from the database.

The database can also comprise datasets for driving modes that can be suitable for larger groups of drivers. For example, the database comprises one or more datasets correlating to a driving mode and/or a driving characteristic selected from a group comprising a comfort driving mode, an energy saving mode, a sport mode, a highway mode, a city traffic mode, a long-distance mode, a working mode, a training mode, a persons transport mode, a goods transport mode, a hazardous goods transport mode and a synthetic dataset, for example from a simulation.

For example, a signal is transmitted electrically between the human-machine interface and an actuator for controlling the vehicle. In particular, that the vehicle or at least some of its components are controlled by x-by-wire control (for example, drive-by-wire, shift-by-wire, brake-by-wire, electronic gas pedal (e-gas pedal) and/or steer-by-wire. In this context, a signal for controlling the vehicle is for example input at the human-machine interface. A human-machine interface can be, for example, a joystick, a touchpad, a touch-sensitive surface, a touch-sensitive screen, a rocker switch, a pedal, a rotary control and/or others.

By conducting the method according to one or more of the preceding example embodiments, it is possible that the driver can assume individual controls himself and the assistance system of the vehicle assumes the remaining controls for safe guidance of the vehicle. When the method is conducted in such a manner, it is possible in particular that—if the assistance system recognizes that an input of the driver would place the vehicle in a critical driving state—this input signal is not forwarded directly to an assigned actuator, but rather before being transmitted to an actuator, the signal is modified such that the vehicle remains in a stable driving state when the action associated with the modified signal is executed by the actuator.

With a method such as described above, it is furthermore possible that the driver thereby experiences an improvement of the vehicle guidance compared to the driving style that would result from a direct enactment of his control signals. In this context, this improvement of the vehicle guidance is possible without the driver having to adapt his own behavior and/or his driving style. By selecting a certain driving mode, the nature of the improvement can be adapted depending on the desired goal of the improvement. It is thus conceivable, for example, that by such a method the driving comfort, the energy efficiency, the experienced sportiness, the safety, the behavior in unfamiliar or challenging situations (for the driver) and/or other situations is improved, compared to the conditions that would arise with a direct enactment of the control signals of the driver.

In some embodiments, a human-machine interface comprises an optical and/or acoustic signal encoder. Such a signal encoder can be realized, for example, as a display element by which the driver is shown a message about a deviation from the driver input expected by the assistance system and the input actually made. Thus it is conceivable, for example, that the driver is shown, on the one hand, a trajectory on which the vehicle would move with the actual steering command, but on the other hand, a target corridor within which the vehicle should move according to the precalculation of the assistance system. Acoustic and/or haptic signals could also indicate the departure from such a corridor, for example, to the driver.

In connection with the increasing availability and use of vehicles that can be driven (partially) autonomously, it is expected that the proportion of driving segments in which a vehicle is (solely) controlled by a human, will fall. Accordingly, the driving experience of humans will diminish. It is therefore to be expected that situations will arise more frequently in which a driver will bring the vehicle (supported by an assistance system, as the case may be) guided by him into a critical driving state by an unsuitable control signal. The method described in some embodiments above is suitable for preventing such a critical driving state. Nevertheless, it can be beneficial to give the driver a feedback that the control signal input by him was not enacted directly, but rather modified, by the assistance system or even was not enacted. For example, a learning effect can be triggered in a driver by such a feedback such that in the future, such actions that could result in potentially critical driving situations can be prevented.

For example, the driver may be given a feedback about a deviation of his driving instruction detected by the human-machine interface from an expected (by the assistance system or, respectively, one of its components) input for moving the vehicle on the precalculated travel path. The driver can thereby be made aware that his input had to be changed by the assistance system to keep the vehicle in a stable state.

However, this method variant is not limited to preventing critical driving states. Rather, when the method is conducted in such a manner, feedbacks about other driving situations may for example be given to the driver, which are classified as more favorable. Thus, in dependence on a preselection of the driver, for example, a feedback can occur when a more energy-saving driving style would be possible in a certain situation. Similarly, a feedback about a possibility of a driving style having lower (transverse) acceleration (for persons transport, for example) or an particularly safe driving style with larger safety reserves (for persons transport or hazardous goods transport, for example) is also conceivable, depending on the situation. Accordingly, training for a preselectable driving style is possible. Such a method can also find applications in motor sports, for example, to highlight to a driver the possibility of a vehicle guidance for faster (curve) driving.

For example, a data point correlating to the feedback is stored in a database. It can be determined from a plurality of such data, for example, whether certain inputs of the driver that would potentially result in critical driving situations were made repeatedly. It may be possible to make inferences about specific driving modes of the driver and/or specific driving characteristics from these data. Independently therefrom, the storing of such datasets enables being able to detect and/or document a learning and/or training effect of the driver based on data correlating to a plurality of feedbacks. These data can be significant for the insurance sector, for example. In the above-described application in motor sports, the training progress of a driver can be detected and the training can be intentionally oriented, as the case may be.

For example, the critical correlation limit value is established (by the driver or another authorized person or source). This critical correlation limit value can represent a degree of decoupling between the control command of the driver and that by the vehicle (or one or more of its actuators). For example, this critical correlation limit value can be separately established for individual control signal encoders and/or control signal encoder groups. By establishing the critical correlation limit value in such a manner, it can be predetermined, for example, from what deviation between the driving instruction given by the driver and the precalculated travel path of the vehicle and/or the precalculated vehicle state, is the driving instruction of the driver no longer directly enacted. If the critical correlation limit value for a gas pedal actuation (acceleration), for example, is set lower than a critical correlation limit value for an actuation of a brake, an intervention by the system occurs very early in the absence of a braking command, whereas only when a gas pedal actuation deviates very significantly from an expected (and leading to a safe vehicle state) acceleration signal, the system will effect a modification of this input signal.

For example, unfavorable driving patterns and/or unfavorable driving characteristics are recognized based on data from a plurality of trips of a driver. The foundational data are for example selected characteristic of at least one feature from a group that comprises a driver identification, a vehicle occupant identification, a vehicle identification, previous instances of falling short of a critical correlation value by the present driver and an attribution of a previous instance of falling short of a critical correlation value to a control signal or a control signal group. It is thereby possible, for example, that instances of a falling short of a critical correlation value are frequently recognized for a certain driver, said instances correlating with a too-late initiation of a braking action and therefore an unfavorable driving pattern and/or unfavorable driving characteristics. The driver could be informed thereof (at regular intervals, for example), to train him toward an improved driving style. Moreover, these data can be relied on to predict future inputs of the driver.

For example at least one sensor monitors and/or recognizes the driver and/or a vehicle occupant. It is thereby possible for a control signal to be attributed exactly to this driver and/or vehicle occupant. Monitoring and identifying the occupants can be advantageous and/or necessary if an occupant assumes control of the vehicle and intervenes in the vehicle control only once the trip is underway. Moreover or supplementarily, the presence of certain vehicle occupants, for example babies or small children, could trigger a preselection of a different driving characteristic with low (transverse) acceleration, for example. Similarly, it is conceivable in this case that control signals from exactly these vehicle occupants are not interpreted as control signals (or respectively, any deviation of a driving instruction given by a baby or small child from a driving instruction correlating to the precalculated travel path of the vehicle and/or the precalculated vehicle state is interpreted as falling short of the critical correlation limit value).

In a specific variant of the method, a virtual three-dimensional space is set up by the assistance system, the dimensions of which are
a degree of decoupling of a driver input to the human-machine interface from a corresponding actuator signal,
a degree of manipulation of the control signal given by the driver in an energizing of a corresponding actuator, and
an intensity of a feedback to the driver.

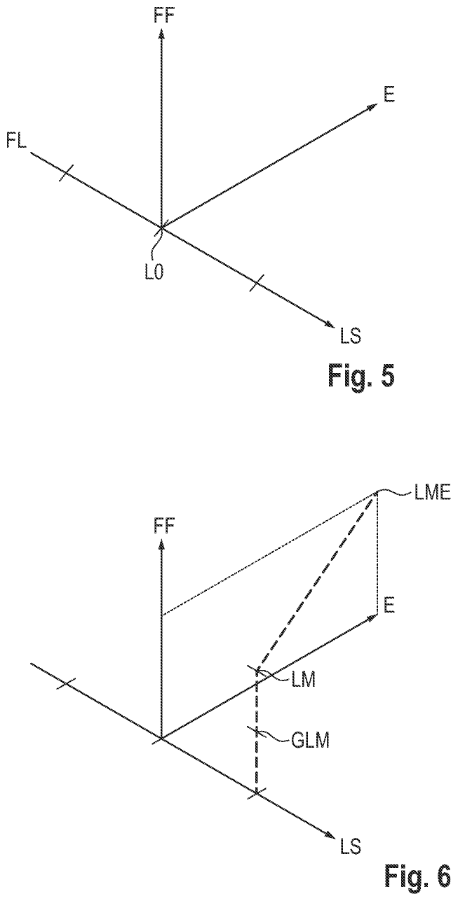

For example, each driver is assigned at least one point in this virtual space by the assistance system. This point correlates to a control and/or feedback behavior of the assistance system that is suitable for this driver and/or experienced by this driver as pleasant. The possibilities that arise from such an assignment are shown for an exemplary conducting of the method, particularly in connection with FIGS. 5 and 6, however apply generally within the scope of this invention.

For example the point assigned to a driver is displaced along a for example steady curve within the above-described three-dimensional space depending on the driving situation. It is thereby possible to convey to the driver a different driving feeling on long-distance trips, for example, than on a leisurely trip (in city traffic, for example) or a slow trip (when maneuvering, for example). It is therefore conceivable that every driver is assigned a curve within this three-dimensional space and the above-mentioned point, which for example defines the correlation between the human-machine interface and an actuator energizable by this human-machine interface, is arranged on this curve depending on the driving situation. By such a systematic and shared exploitation of the above-mentioned degrees of freedom, it is possible to convey to the driver a pleasant control, or respectively, steering, feeling that conceals the (heavy, as the case may be) interventions of the assistance system. However, the driver does receive a feedback about his action and a desired (very direct, for example) steering feeling.

A point as described above in this three-dimensional space and/or a curve arranged therein can be created individually for every driver, for example, determined by the assistance system (from historical driving data of this driver, for example) and/or factory preset for a certain driver group. The positioning of this point and/or the run of the curve may be changed by the driver. For this purpose, it is for example provided that characteristics of a driver are recognized by the assistance system and the curve is adjusted according to these characteristics. If the inputs of the driver correlate to a rather sporty driving style, for example, the degree of decoupling could be increased and an even more sporty driving style than is actually carried out by the vehicle is simulated for the driver by augmented feedback and the simulation of a more direct/immediate intervention in the driving style.

Another example of a displacement of the point or the curve can be given when the assistance system is used for training a driver and a positive training effect takes hold. In such a case, the degree of decoupling can be reduced and the driver thus granted more possibilities for individualizing the (actual) driving behavior of the vehicle.

For example, in addition to the step mentioned above from among the steps a) to f) and or the multiple of the steps a) to f), particularly multiple further of the above-described steps are carried out as computer-assisted, for example as computer-implemented method steps. In particular, it is wanted that all steps necessary for carrying out the chosen method variant are carried out as computer-assisted, for example as computer-implemented method steps. In this context, a single (especially processor-based) computer system can be used or multiple separate computer systems. In this context, a computer system can comprise multiple computing apparatuses that can execute (in parallel, as the case may be) the different or same method steps (multiple times, as the case may be). These multiple computing apparatuses can be arranged on a shared chip, for example, or be designed as virtual computing apparatuses on a computer system.

for example the method, i.e. at least one method step, is executed with the use of a machine learning model, especially a trainable one. In this context, the model for example comprises a set of parameters, in particular trainable ones, which are set to values that were learned as the result of a training process.

At least one computer apparatus may be connected to a data network, at least temporarily. Thereby can be enabled that the computer system, or respectively the computer apparatus, receives updates and thus can be taught to recognize new hazards, for example, or improve, i.e. make more accurate, an algorithm for calculating a hazard risk (resulting from a falling short of a critical correlation limit value, for example). The data network can comprise a computer apparatus with an artificial intelligence system that receives data from a plurality of computer apparatuses (particularly of various vehicles) and generates improved algorithms from these data for calculating a hazard risk for hazard situations actually occurring in individual vehicles and those not actually occurring.

For example the machine learning model is suitable and intended for executing a (computer-implemented) computer method in which (computer-implemented) perception and/or detection tasks are executed, for example (computer-implemented) methods for semantic segmentation and/or (computer-implemented) object classification. In this context, in the object classification a signal is assigned to a (previously taught-in and/or preset) class, said signal being detected and/or shown in the measurement values (or the sensor data characteristic of the measurement values). The classes can be (among others) a meaning (particularly in relation to a driving instruction or a changed travel path) of a detected signal and/or a notification value characteristic of a meaning of the detected signal.

For example the machine learning model is based on an (artificial) neural network (AI—artificial intelligence). For example the sensor data (or data derived therefrom) is fed to the artificial neural network as input variables. For example the artificial neural network maps the input variables onto output variables in dependence on a parameterizable, or respectively parameterized (by the trainable, or respectively trained, parameters), processing chain.

For example, such a neural network can be realized as a Deep Neural Network (DNN) in which the parameterizable processing chain has a plurality of processing layers, and/or a so-called Convolutional Neural Network (CNN) and/or a Recurrent Neural Network (RNN). For example the parameterizable processing chain is parameterized by the training. For example datasets relating to the above-described (basis) datasets and/or training datasets are used as training data. For example the training is done by supervised learning. However, it is also possible to train the artificial neural network by means of unsupervised learning, reinforcement learning or stochastic learning.

The present invention is furthermore directed to an assistance system for at least partially autonomous control of a vehicle. This assistance system comprises a sensor apparatus for detecting environmental data, a first computer apparatus for precalculations based on the environmental data of a first travel path of the vehicle to a destination and of a vehicle status at at least one point of this travel path. The assistance system is furthermore distinguished by at least one human-machine interface that is intended and configured for detecting a state and/or a driving instruction of a driver, as well as a correlation value determination apparatus that is intended and configured for determining a correlation value based on the driving instruction and the precalculated travel path of the vehicle and/or the precalculated vehicle state. Moreover the assistance system comprises a second computer apparatus that, when a correlation limit value is fallen short of, is intended and configured for converting a data point detected by the human-machine interface that is characteristic of the state and/or of the driving instruction of the driver into a control signal, which is not identical to the detected data point, wherein the control signal correlates to a second travel path leading to the same destination on which the vehicle can be guided in a stable vehicle state at every point.

Such an assistance system for example has all necessary components to carry out the above-described method. In particular, it is configured, suitable, and/or intended for executing the above-described method as well as, individually or in combination with one another, individual or all of the method steps already described above in conjunction with the method. Conversely, the method can be executed with all of the features described in the scope of the assistance system, individually or in combination with one another.

As already described above in relation to the method, such an assistance system enables the vehicle to be guided to the chosen destination safely, even with control signals of a driver that could potentially lead to a critical driving situation.

In connection with the present invention, a “second travel path” is understood to be a travel path that leads to the same driving destination as the first travel path. For example, this driving destination does not have to be the final destination of a trip, but can potentially also be an interim destination. The second travel path does not necessarily have to differ from the first travel path in its geometrical realization. It is also conceivable that it is identical in form to the first travel path. However, it may differs from the first travel path in at least one feature. This feature can be a characteristic value of the vehicle that moves on this travel path (or respectively, is expected to move in the future). This characteristic value can be a speed, a distance to an obstacle, a steering angle, another vehicle position and/or orientation and/or something else.

For example the human-machine interface of the assistance system comprises a feedback apparatus by means of which a result of the correlation value determination by the correlation value determination apparatus can be conveyed to a driver. It is thereby possible to impart to the driver when his input to the human-machine interface deviates from an input that would be expected to this human-machine interface for moving the precalculated travel path.

The output of the feedback, however, can be output at a different place than the place where the control signal was input. This place can be a display apparatus, for example. On this, a message to the driver can be given about his input and—if it differs from the expected input—about this deviation. It is also conceivable to inform the driver early about an input expected in the future. Thus a view of a future route section could be inserted for the driver, on a display apparatus, for example. This route section can be characterized with information about (driver) inputs expected at certain points of this route section. If deviations from these expected inputs arise, the assistance system can derive an intention of the driver that he desires a different driving experience, and/or the assistance system can make the driver aware of this deviation to trigger a training effect and bring about improved driver inputs in the future.

For example a strength of a feedback signal of the feedback apparatus correlates to an amount by which the correlation limit value is fallen short of. The driver can thus find out whether his input deviated from the expected input signal strongly or only slightly. For example a ratio of the strength of the feedback signal to the amount of the falling short can be preset by the driver. By the possibility of setting such a ratio, it can be achieved that a driver is not, not excessively, often or always informed of deviations of his input from the expected input signal. An overload of information can be prevented in particular for unexperienced drivers by selecting a suitable ratio.

For example the human-machine interface is electrically connected to an actuator for controlling the vehicle. This enables components of the assistance system to recognize, evaluate and, as the case may be, modify in such a way that correlates to a changed energizing of the actuator, a signal encoded by the human-machine interface over this connection. In a various embodiments, the human-machine interface is part of an X-by-wire control of the vehicle, in particular drive-by-wire, shift-by-wire, brake-by-wire, electronic gas pedal (e-gas pedal) and/or steer-by-wire.

For example there is a data connection between the second computer apparatus and a database. Data about driving characteristics of a driver, multiple drivers, a driver group and/or various driving modes are for example stored in the database. It is thereby possible to adapt the control signal generated or modified by the second computer apparatus to certain driving characteristics of a driver, multiple drivers, a driver group and/or various driving modes. For example at least one of the datasets stored in the database correlates to a driving mode that is selected from a group comprising a comfort driving mode, an energy saving mode, a sport mode, a highway mode, a city traffic mode, a long-distance mode, a working mode, a training mode, a persons transport mode, a goods transport mode and a hazardous goods transport mode. A driving mode that is suitable for the driver or probably most closely approximates the desired driving profile can thus be selected by the driver, for example, or another authorized person or source (the assistance system itself, for example).

For example at least one of the apparatuses, maybe multiple of the apparatuses, in particular each of the apparatuses from a group comprising the first computer apparatus, the correlation value determination apparatus and the second computer apparatus, is a computer-implemented apparatus. In some embodiments, multiple of these apparatuses are implemented on a shared computer system. Such an embodiment has been shown to be especially space-saving and due to the shortened (data) transmission paths, as especially rapid.

For example the correlation value determination apparatus and/or the second computer apparatus is an artificial intelligence system or is in data connection with such a system, at least temporarily. In this context, for example the correlation value determination apparatus and/or the second computer apparatus are provided and configured for recognizing a pattern in the deviation of the correlation between the driving instruction of the driver and the expected driving instruction of the driver to follow the precalculations of a travel path. This pattern is for example stored in a database that forms a foundation for future calculations of a travel path of the vehicle. Control signals received from a driver can thus be relied on to recognize his desired driving style and/or his driving characteristics, and on the basis of these data to calculate future travel paths that more closely resemble the desired driving style and/or driving characteristic of a driver.

The present invention is furthermore directed to a vehicle, in particular a motor vehicle, comprising an above-described assistance system corresponding to an embodiment and/or directed to a vehicle suitable for executing a method as described above. In particular, the vehicle may be a (motorized) road vehicle.

The vehicle may be a motor vehicle which is, in particular, a semi-autonomous, autonomous (for example, of autonomy level 2+, 3 or 4 or 5 (of standard SAE J3016)), or a self-driving motor vehicle. Level 5 autonomy describes fully automatic vehicles. The vehicle can be controlled by a driver or drive autonomously. Moreover, in addition to a road vehicle, the vehicle may also be an air taxi, an airplane and another means of locomotion or another type of vehicle, for example an aircraft, watercraft, or rail vehicle.

The present invention is also directed to a computer program or computer program product, comprising programming means, in particular a program code which represents or codes at least some and may be all of the method steps of the method according to the invention and for example one of the described embodiments and is designed for execution by means of a processor apparatus.

The present invention is also directed to a data memory on which at least one embodiment of the computer program according to the invention or embodiments of the computer program is stored.

Further benefits and embodiments are apparent from the appended drawings:

### BRIEF DESCRIPTION OF THE DRAWINGS

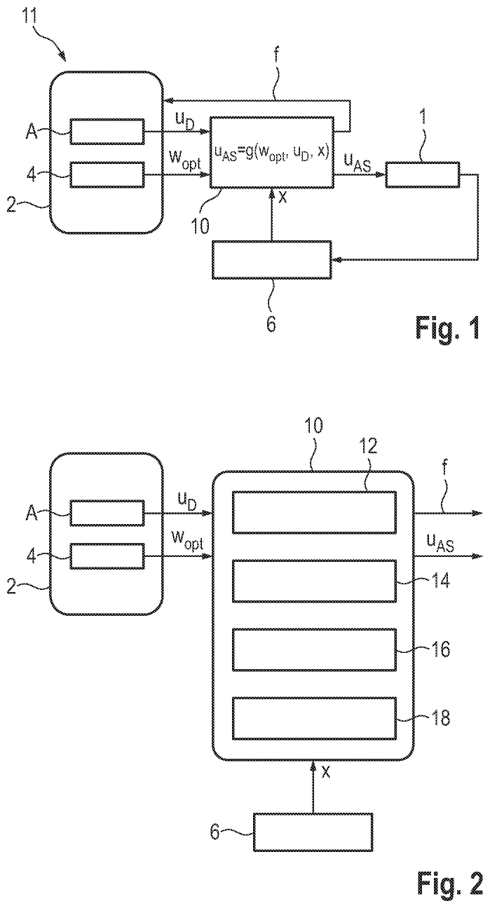

FIG. 1 shows a schematic representation of a part of the proposed method according to an embodiment. The system 11 comprises a driver 2 labeled with reference sign 2, the assistance system 10 on which at least parts of the method are carried out, and the vehicle 1 and its actuators, which enact control signals of the assistance system 10.

The driver 2 executes an action labeled with reference sign A. This action correlates to a control signal u_{D} which is transmitted to the assistance system 10. The control signal can be generated based on an input (or respectively, action A) of driver 2 by, for example, a human-machine interface (not shown separately).

Moreover, the assistance system 10 receives an information w_{Opt} which correlates to a desired driving experience 4 of the driver 2. This driving experience 4 is also described as “optimal driving experience”. The desired, or respectively, optimal, driving experience for the driver 2 can be transmitted by him to the assistance system 10 by a selection, or following a driver identification, the assistance system 10 independently selects a probably desired dataset that correlates to the desired, or respectively, optimal, driving experience.

Based on control signal u_{D} and the information w_{Opt}, the assistance system 10, which is also described in the scope of this invention as “Driving Enhancing System” or also as “Advanced Driving Enhancement system”, calculates a changed control signal u_{AS}. This is a function g based on the input variables u_{D} and w_{Opt}, as well as further factors which are summarized under the symbol “x”. Further factors include, in particular, the (already calculated, as the case may be) travel path to a destination as well as environmental factors, such as obstacles, other traffic participants, roadway condition, route course and others.

The changed control signal u_{AS} is then transmitted to the vehicle 1 or, respectively, its control apparatus and/or actuators. In step 6, the vehicle in turn determines information about the current driving state and/or driving situation by means of one, For example multiple suitable sensors (not shown). Other factors can also be involved, such as fill level of an energy store, occupation state of the occupant space, loading state of a loading space, a weather data point, a state of the tires and others. The result of the determination of these factors (summarized here by the symbol “x”, as explained above) is transmitted to the assistance system and there used for calculating the changed control signal u_{AS}.

If the driver 2 desires a feedback f, for example about a deviation of his given control signal u_{AS} from the changed control signal u_{AS}, this can be given to him via a corresponding feedback channel f.

FIG. 2 shows a schematic representation of a further part of the proposed method according to an embodiment, wherein the focus is placed on the steps carried out by the assistance system 10. As shown in FIG. 1, the assistance system 10 receives the control signal u_{D}, the information w_{Opt} as well as the data summarized under x and based thereon, calculates the changed control signal u_{AS}. The changed control signal u_{AS}, as well as the feedback signal f, if desired, are output as described above to the vehicle, or respectively, the driver.

For this purpose, the steps which are carried out by the assistance system 10 described with reference signs 12-18 are provided in a method variant.

Then in step 12, a prediction of the driver action and/or an interpretation of the situational driver desire is effected. Data which were recorded under similar environmental conditions could be relied on for a prediction of the driver action. If such a dataset exists, it can be read from this how the driver reacted to such a situation in the past. It is more probable that he will act similar in the situation just detected.

Alternatively or supplementarily thereto, the situational driver desire can be interpreted. This interpretation can be done, for example, such that it is inferred from an actuation of the gas pedal that the driver wants to reach an (interim) destination especially quickly or wants to drive especially sportily.

In the optional step 14, the prediction is improved by taking into account the optimization goal. If a comfortable trip, for example, is selected as optimization goal, while conversely the prediction was made on the basis of a sporty driving style, the prediction can be adapted accordingly.

In step 16, the assistance system 10 determines an assistance demand for improving the action A of the driver 2 for achieving the optimal driving experience 4. If augmented comfort was identified as the optimal driving experience 4, strong accelerations and/or strong steering angle is not necessary for achieving this goal or is even counterproductive. In such a case, an assistance demand would be established.

Moreover, a check is performed in step 18 as to whether traffic and interactional safety is ensured. An action 4 of the driver 2 is not executed if a vehicle state would result therefrom that would endanger traffic safety. Similarly, an action 4 of the driver 2 that is identified as not intentional is not executed.

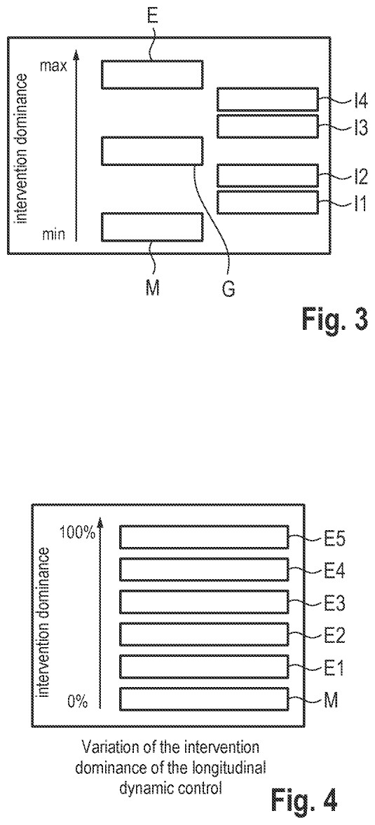

FIG. 3 shows an exemplary representation of the possible decoupling between human-machine interface and actuator. Such a decoupling is possible by an x-by-wire architecture, in particular. It offers many possibilities for assisting the driver. Similarly, it is possible to give the driver a feedback if the assistance system deviates from a control command of the driver. For example, the driver can be informed of lane-guiding steering torques. If a steer-by-wire system is provided, the connection between steering wheel and front wheel and/or gas pedal and/or brake pedal can additionally resolve longitudinal force and (partially) decouple the driver.

The possible driver assistance ranges from hardly perceptible interventions through to complete decoupling. This variation of the intervention possibilities between human-machine interface and actuator is described as “intervention dominance”. This can be established between a minimum (“min”) and a maximum (“max”) value. In this context, a minimal value corresponds to a manual trip M without intervention by an assistance system. Maximum intervention dominance exists when an input of the driver is completely decoupled E from the action that the vehicle actually executes. Between these minimum and maximum positions, there is a wide range in which an assistance system assists the trip, or respectively, the driver; such a position is labeled with the reference sign G (“guided”).

Various gradations are conceivable for the degree of decoupling, or respectively, the intervention dominance. In the example shown, for example, a low assistance of the driver is labeled with reference sign I1. This can be done through an audio-visual or acoustic information, for example a warning lamp or a signal tone.

Additionally, in all modalities for assistance, the intervention dominance can be enacted differently and coordinated situationally. These modalities are, for example, longitudinal guidance, transverse guidance, optical information (by blinking lights, head-up display or other) as well as acoustic information. However for the transverse guidance modality, a further distribution of the interaction via the human-machine interface is beneficial. These modalities are, however, simplified to a summarized consideration, below.

Farther-reaching assistance can be offered, for example at point I2. This could occur directly at the place, for example, at which a corresponding reaction of the driver is expected. This could be, for example, a haptic information of the input device, such as a vibration of the steering wheel whenever there is a hazard of leaving the present roadway.

I3 stands for a farther-reaching decoupling. In such a decoupling, the vehicle independently assumes control over certain functions. The driver no longer needs to control the input device associated with this function. An example of such a decoupling degree is the active vehicle guidance, by lane-guiding steering torques (lane assist), for example. In such a case, however, it is possible for the driver at any time to obtain control over this function and by an intervention, to compel a lane change of the vehicle, for example.

Conversely, the situation is different in I4. The function of an emergency brake assistant, for example, is arranged within this range of the decoupling degree. This executes an emergency braking namely decoupled from (at least some other) actions of the driver. For example, the driver is namely prohibited from an acceleration of the vehicle while the emergency brake assistant is triggered. A corresponding input (at the gas pedal, for example) would not be executed. There thus is at least a partial decoupling.

FIG. 4 shows a further exemplary representation for decoupling between human-machine interface and actuator, using as an example the variation of the intervention dominance of the longitudinal dynamic control. At 0% intervention dominance M, the vehicle is manually controlled with minimal intervention dominance M, analogously to the situation shown in FIG. 3.

Here, reference sign E1 stands for a lower degree of decoupling in which, for example, an impending hazard is indicated acoustically or audio-visually. The reaction to such a warning must be by the driver, however. By manually actuating the brake, for example.

An elevated degree of decoupling is given at reference sign E2. Some functions of the longitudinal dynamic control are decoupled here, and can thus no longer be executed by the driver. It is conceivable, for example, that a signal for accelerating the vehicle (depressing the gas pedal, for example) is not, or not to its full scope, enacted into an acceleration of the vehicle.

At the positions described with reference signs E3, E4 and E5, there is a farther-reaching decoupling of the longitudinal dynamic control by braking intervention by the assistance system. This braking intervention can be variously graduated and is lowest at E3 with a light brake intervention and increases over an increasing brake intervention at E4, up to a complete brake intervention by the assistance system at E5.

FIG. 5 shows a representation of a virtual space that is set up by the possible degrees of freedom of the decoupling between the human-machine interface and actuator as well as the feedback. Such a space is set up, in particular, by an x-by-wire architecture and offers many possibilities for assisting the driver.

Within this space, the axis E spans a degree of the decoupling as shown in FIGS. 3 and 4. At the origin, there is no decoupling and the driver controls manually. Complete decoupling is achieved at the end of the axis E. There, the assistance system assumes complete control of the controlling of the vehicle and possible interventions of the driver at the steering wheel have no direct influence on the driving process. For example, the driver action continues to be interpreted by the ADES so that for the driver, it could still feel as though he has direct control of the driving process.

The axis extending between the points FL and LS stands for a degree of manipulation of the control signal given by the driver in an energizing of a corresponding actuator. This axis stands for the degree of freedom of an x-by-wire architecture, that the feedback to the user does not have to correlate directly with the real reactions acting on the vehicle. By such a manipulation of the control signal, a different actuator signal can be assigned to an identical control signal, depending on the driving situation.

At the origin L0, the driver does not experience any familiar steering feeling, at a steering wheel, for example, upon actuation but rather the steering wheel would rotate almost completely torque-free into a steering position desired by the driver. If the tuning moves in the direction of the axis LS, a steering feeling is simulated that correlates to the current driving situation, wherein the strength of the feedback can be varied, in a manner roughly comparable to the change of a servo steering assistant. It is conceivable, however, to change the actuator signal depending on the vehicle speed, thus to facilitate maneuvering at low speeds for the driver. This change can go so far that the driver perceives a notional steering feeling FL, which is not at all related to the steering angle actually effected at the actuator.

Another extreme is given at point LS, at which the driver experiences a driving feeling as though each of his inputs were transmitted directly to the actuators and thus to the road. Since, however, such a direct transmission does not exist with a steer-by-wire system, it is conceivable that at point LS, a simulation of a direct transmission of his inputs to the actuators is simulated for the driver.

The axis FF characterizes a direction in which an intensity of a feedback to the driver (“driver feedback”) rises. This feedback is independent of the manipulation of the control signal into an actuator signal. Nevertheless, a feedback signal can overlay a control signal and vice versa. Thus, a steering wheel vibration, for example, is tangible at the steering wheel upon driving on or driving over a roadway delimiter, and as the case may be, overlays a force that is necessary for angling the steering wheel. This axis is comparable to the intervention possibilities as enabled by systems without x-by-wire architecture in which the degree of freedom in the decoupling or steering feeling simulation is not possible.

FIG. 6 shows an example of a recoupling profile in the virtual space, as it is shown in FIG. 5. As illustrated by the curve, which is shown merely as an example, such a system can occupy every point in the space set up by the three described degrees of freedom. Thus, for example, departing from a chosen correspondence between control signal and actuator signal on the axis LS, a feedback for a driver can be selected along the axis FF. For example, feedback signals with a low steering torque GLM and a strong steering torque LM are shown. Such a steering torque can even be given as feedback to the driver when the control signal is completely decoupled from the actuator signal. That means that even if the assistance system has assumed complete control of the steering and thus a steering wheel angle would not be enacted into a direction change, the driver can be given an actuator signal as feedback by transmission of a steering torque during complete decoupling LME.

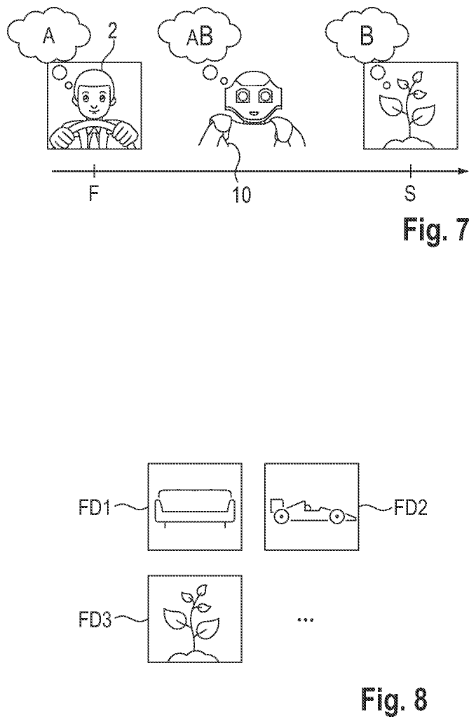

FIG. 7 shows a schematic representation of the working of the assistance system 10. The assistance system 10 is capable of recognizing an action A of driver 2. This action 2 of the driver does not have to be the best-possible action A to reach a destination desired by the driver 2. It is merely an action regarded as suitable subjectively by the driver.

Information from various sensors and about the chosen driving destination is also available to the assistance system. Similarly, this information B determined by, or “objectively” available to, the system s must be taken into account.

The assistance system 10 shown here illustratively must therefore understand the subjective desire of the driver as well as possible and emulate it such that the driver ideally cannot distinguish whether the driving states are resulting on the basis of his direct actions or on the basis of the indirect emulation of his subjective driving desire. As soon as the system is capable of (at least partially) emulating this subjective driving desire, it becomes possible for the subjective driving desire to be improved in the direction of the “objective” driving destination B. A planning adaptation AB is therefore necessary. The “subjective” desire of the driver is displaced in the direction of an “objective” driving destination.

FIG. 8 shows a schematic representation of selected driving modes FD1-FD3, which can also be an “objective” driving destination B or be relied on for calculating an “objective” driving destination B. The icons assigned reference signs FD1-FD3 show, merely as examples, driving modes such as comfort FD1, sport FD2 and environmental FD3.

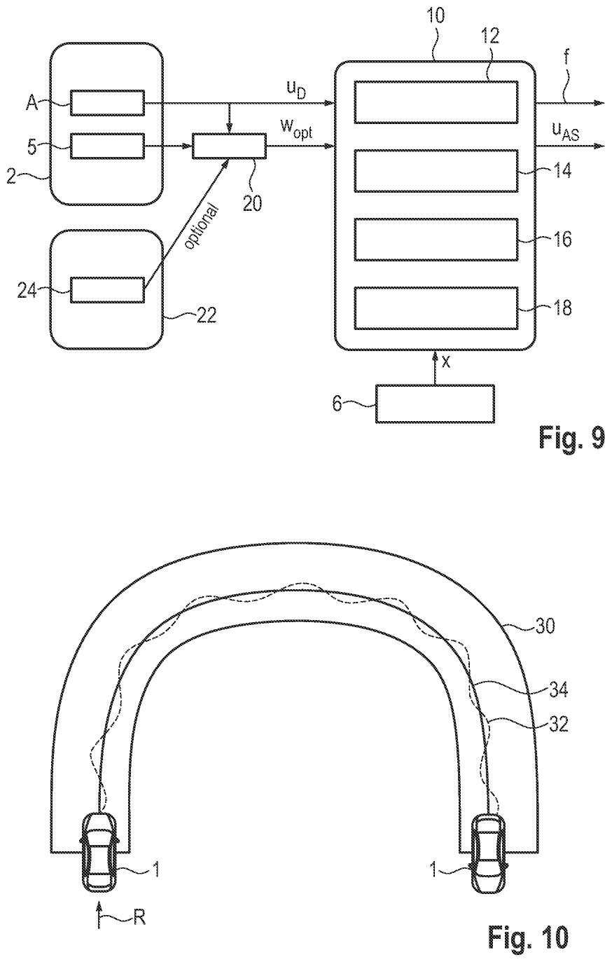

FIG. 9 shows a further schematic representation of a trip of a vehicle using a method variant. This method corresponds in parts to the method shown in FIG. 2, such that merely the method steps that differ from the method shown in FIG. 2 are described in detail.

The essential difference compared to the method shown in FIG. 2 is that the input signal w_{Opt} relied on by the assistance system for calculating the changed control signal u_{AS} is not based solely on the driving behavior desired by the driver. Rather, according to this method variant, it is provided that aside from the desired driving experience 4 of the driver 2, the desires and needs labeled with reference sign 24 of further vehicle occupants 22 are relied on for calculating the optimal driving experience 20 and therefore also the input signal w_{Opt}.

Thus the information w_{Opt} can be adapted, for example automatically, such that the trip is experienced as appropriate by most of the occupants. For example, if a baby is identified as a vehicle occupant, a trip with the lowest possible acceleration forces is regarded as especially worthwhile and the precalculated trip is optimized in this regard.

FIG. 10 shows a schematic representation of a trip of a vehicle 1 using a method variant. In the example shown, the vehicle 1 is intended to drive round a curve 30 along the direction R. For this, a first travel path (not shown) was calculated by the assistance system. In the example shown, however, the steering signals of the driver do not correspond, or correspond only conditionally, to a trip along this first travel path. The steering signals do not correspond to the calculated trajectory, for example due to a lack of driver experience and/or due to the use of an unfamiliar human-machine interface, such as a joystick or touchpad, but rather to a meandering trajectory 32.

In this case, the assistance system recognizes the intention of the driver to drive round the curve and combines this intention with a possible driving destination, namely driving round the curve in a resource-saving manner and/or with as small transverse acceleration peaks as possible. In this case, the assistance system corrects the curve trip such that the vehicle locomotes on the second travel path, the trajectory 34—despite the different input of the driver. A far-reaching decoupling of the driver is thus effected—at least with regard to steering and at least temporarily.

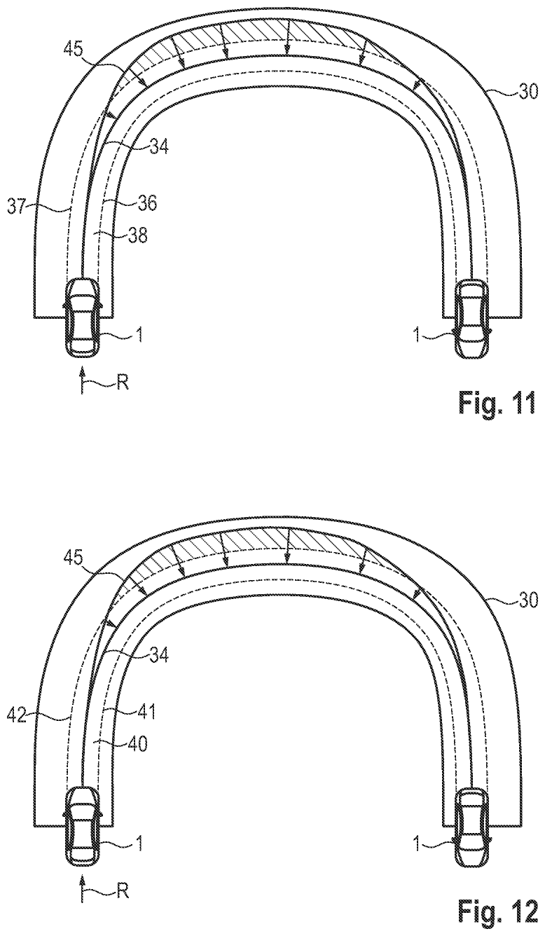

FIG. 11 shows a further schematic representation of a trip of a vehicle 1 using a method variant. In the example shown, the driver is driving toward a curve 30 unfamiliar to him. Under the conditions under which he would drive into this curve, he would depart from a consistency region labeled with reference sign 38 in which this driver would normally be expected to drive, and the vehicle 1 would enter (hazard) region 45, at least temporarily. The assistance system recognizes this hazard resulting from the error-prone energizing by the driver or the resulting disadvantageous driving experience, and corrects the control signals of the driver such that the vehicle 1 drives safely or according to subjective perception, in an optimized manner, along the recalculated trajectory 34, which lies completely within the safe target corridor 38 and the consistency region of this driver.

The target corridor 38 for the respective curve 30, for example, can be preset by corresponding navigation data. For example, the target corridor 38 is calculated from the navigation data and a consistency range for this driver known to the assistance system. Thus information from driving around prior curves by this driver can be used for calculating driving around this curve. Thus a different driving ability and/or preference of this driver, for example, can also be relied on for calculating driving around a curve safely in the future.

FIG. 12 shows a schematic representation of a very similar situation to that of FIG. 11 of a trip of a vehicle 1 using a method variant. High driving comfort has been chosen as the goal here, however. In driving around the curve 30, this goal cannot be achieved if the vehicle 1 follows the control command of the driver and enters the region labeled with reference sign 45 (with high transverse acceleration, for example). The assistance system therefore intervenes and based on the control data of the driver, calculates a second travel path 34 that lies completely within the comfortable region 40. Next, the vehicle (decoupled from driver commands, as the case may be) is guided around the curve 30 on the trajectory 34 by a corresponding changed energizing of the actuators.

The applicant reserves the right to claim all the features disclosed in the application documents as essential to the invention in so far as they are novel individually or in combination with respect to the prior art. Furthermore, it is pointed out that in the individual FIGS. features were also described which may be beneficial per se. The person skilled in the art recognizes immediately that a specific feature described in a Fig. may also be beneficial without the incorporation of further features from this FIG. Furthermore, the person skilled in the art recognizes that advantages may also result from a combination of several features shown in individual FIGS. or in different FIGS.

### LIST OF REFERENCE NUMERALS

1 Vehicle
2 Driver
4 Desired, optimal driving experience
6 Current driving state, current driving situation
10 Assistance system, Driving Enhancing System
11 System
12, 14, 16, Method steps
18
20 Optimal driving experience
22 Vehicle occupants
24 Occupant desire, needs
30 Roadway, curve
32 Trajectory, poor driving pattern
34 Calculated/driven trajectory
36, 37 Limits of the consistency region
38 Consistency region
40 Comfort region
41, 42 Limits of the comfort region
45 (Hazard) region
A Action
u_{D} Control signal
w_{Opt} Information
u_{AS} (Optimized) control signal
x Further factors
F Feedback
E Decoupling
G Assistance, guidance
M Manual trip, manual control
E1 E5 Degree of decoupling
I1-I4 Degree of decoupling
FF Feedback
LS Direct steering feeling
FS Notional steering feeling
L0 Origin
GLM Low steering torque
LM Strong steering torque
Steering torque with complete
LME decoupling
S System
B “Objective” information
AB Planning adaptation
FD1-FD3 Driving modes
R Direction

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

1. A method for controlling a vehicle by an assistance system, comprising:
a) detecting environmental data of a vehicle using a sensor;
b) calculating a first travel path of the vehicle to a destination, and calculating a vehicle state at at least one point of this travel path, based on the environmental data;
c) detecting a driving instruction of a driver using at least one human-machine interface;
d) optionally determining a correlation value based on
the driving instruction and
the precalculated travel path of the vehicle and/or the precalculated vehicle state;
e) optionally checking whether the correlation value falls below a critical correlation limit value by a second computer apparatus, and if the correlation value falls below the critical correlation limit value; and
f) converting a data point detected by the human-machine interface that is characteristic of the state and/or the driving instruction of the driver into a control signal that is not identical to the detected data point, wherein the control signal energizes the vehicle or a vehicle component on a second travel path leading to the same destination, wherein the vehicle adopts a stable vehicle state at every point of this second travel path.

2. The method of claim 1, wherein the second travel path is calculated taking into account data regarding a driving mode and/or a driving characteristic of a driver, multiple drivers and/or a driver group, which are loaded from a database.

3. The method of claim 1, wherein a signal is electrically transmitted between the human-machine interface and an actuator for controlling the vehicle, wherein the vehicle is controlled by X-by-wire control and a signal for controlling the vehicle is input at the human-machine interface.

4. The method of claim 1, wherein a feedback is given to the driver regarding a deviation of his state detected by the human-machine interface and/or his driving instruction detected by the human-machine interface from an expected state and/or an expected input for moving the vehicle on the precalculated travel path.

5. The method of claim 1, wherein the critical correlation limit value is established by the driver or another authorized source.

6. The method of claim 1, wherein disadvantageous driving patterns and/or driving characteristics are recognized based on data from a plurality of trips of a driver.

7. The method of claim 1, wherein at least one sensor monitors and/or recognizes the driver and/or a vehicle occupant.

8. The method of claim 1, wherein one or more of a)-f) are carried out computer-assisted.

9. The method of claim 1, wherein a virtual three-dimensional space is set up by the assistance system, the dimensions of which are:
a degree of decoupling of a driver input to the human-machine interface from a corresponding actuator signal;
a degree of manipulation of the control signal given by the driver in an energizing of a corresponding actuator; and
an intensity of a feedback to the driver;
wherein each driver is assigned at least one point in this virtual space by the assistance system, wherein this point correlates to a control and/or feedback behavior of the assistance system that is suitable for this driver and/or experienced by this driver as pleasant.

10. An assistance system for at least partially autonomous control of a vehicle, comprising:
a sensor for detecting environmental data;
a first processing circuit for precalculating a first travel path of the vehicle to a destination and of a vehicle state at at least one point of this travel path, based on the environmental data;
at least one human-machine interface that is intended and configured for detecting a state and/or a driving instruction of a driver;
optionally a correlation value determination circuit that is intended and configured for determining a correlation value based on the driving instruction and the precalculated travel path of the vehicle and/or the precalculated vehicle state; and
a second processing circuit that is intended and configured for converting a data point detected by the human-machine interface that is characteristic of the state and/or of the driving instruction of the driver into a control signal, which control signal is not identical to the detected data point; wherein the control signal correlates to a second travel path leading to the same destination on which the vehicle can be guided in a stable vehicle state at every point.

11. The assistance system of claim 10, wherein the human-machine interface has a feedback circuit using which a result of the correlation value determination by the correlation value determination apparatus can be conveyed to a driver, wherein for example a strength of a feedback signal of the feedback apparatus correlates to an amount by which the correlation value is fallen short of, wherein for example a ratio of the strength of the feedback signal to the amount of the falling short can be preset by the driver.

12. The assistance system of claim 10, wherein the human-machine interface is in electrical connection to an actuator for controlling the vehicle, wherein the human-machine interface is part of an X-by-wire control of the vehicle.

13. The assistance system of claim 10, wherein there is a data connection between the second processing circuit and a database, wherein data regarding driving characteristics of a driver, multiple drivers, a driver group and/or various driving modes are stored in the database, wherein for example at least one of the datasets stored in the database correlates to a driving mode selected from a group comprising a comfort driving mode, an energy saving mode, a sport mode, a highway mode, a city traffic mode, a long-distance mode, a working mode, a training mode, a persons transport mode, a goods transport mode and a hazardous goods transport mode.

14. The assistance system of claim 10, wherein the correlation value determination circuit and/or the second processing circuit comprises an artificial intelligence system or has a data connection with such a system at least temporarily, wherein for example the correlation value determination circuit and/or the second processing circuit is provided and configured for recognizing a pattern in the deviation of the correlation between the driving instruction of the driver and the expected driving instruction of the driver for following the precalculations of a travel path, and this pattern is for example stored in a database that forms a foundation for future calculations of a travel path of the vehicle.

15. A vehicle, in particular a motor vehicle, comprising the assistance system of claim 10.

16. The method of claim 2, wherein the driving modes are selected from a group comprising a comfort driving mode, an energy saving mode, a sport mode, a highway mode, a city traffic mode, a long-distance mode, a working mode, a training mode, a persons transport mode, a goods transport mode and a hazardous goods transport mode.

17. The method of claim 4, wherein a data point correlating to the feedback is stored in a database to detect and/or document a learning and/or training effect of the driver based on a plurality of data correlating to feedbacks.

18. The method of claim 5, wherein this critical correlation limit value can be separately established for individual control signal encoders and/or control signal encoder groups.

19. The method of claim 9, wherein the point assigned to a driver is displaced along a steady curve within this three-dimensional space depending on the driving situation.

20. The assistance system of claim 10, wherein the second processing circuit is configured for converting the data point into the control signal on falling below a correlation limit value.
